(19) United States
(12) Patent Application Publication
(10) Pub. No.: US 2013/0027438 A1
(43) Pub. Date: Jan. 31, 2013

(54) DISPLAY CAPABLE OF CALIBRATING WHITE BALANCE AND METHOD THEREOF

(71) Applicants: Ming-Hung Hu, Yunlin County (TW); Ying-Hui Chen, Taoyuan City (TW); Kuang-Hung Chien, Taoyuan County (TW)

(72) Inventors: Ming-Hung Hu, Yunlin County (TW); Ying-Hui Chen, Taoyuan City (TW); Kuang-Hung Chien, Taoyuan County (TW)

(21) Appl. No.: 13/241,193

(22) Filed: Sep. 22, 2011

(30) Foreign Application Priority Data
Jul. 27, 2011 (TW) 100126643

(51) Int. Cl. G09G 5/10

(52) U.S. Cl. 345/690

(57) ABSTRACT

A white balance calibration method includes providing red light, green light, blue light, and white light to a display panel according to first image data; detecting a first temperature of a backlight module when the backlight module provides the red light, green light, blue light, and white light to the display panel; detecting whether luminance of white light of each pixel is lower than maximum luminance of a white light emitting diode (LED) corresponding to the pixel when a first difference between the first temperature and a standard temperature stored in a lookup table is less than a predetermined value; controlling the backlight module to turn on a red LED, a green LED, and a blue LED corresponding to the pixel during turning-on of the white light if the luminance of the white light is lower than the maximum luminance of the white LED corresponding to the pixel.

### BACKGROUND OF THE INVENTION

1. Field of the Invention

The present invention is related to a display capable of calibrating white balance and method thereof, and particularly to a display and method thereof that can turn on a red light emitting diode (LED), a green LED, and a blue LED corresponding to a pixel simultaneously or in turn during turning-on of white light corresponding to the pixel between two consecutive synchronous signals to calibrate the white light corresponding to the pixel.

2. Description of the Prior Art

Please refer to FIG. 1. FIG. 1 is a diagram illustrating a liquid crystal display 100 with a predetermined color sequence utilizing a red light emitting diode (LED), a green LED, a blue LED, and a white LED corresponding to each pixel to form a predetermined color according to the prior art. As shown in FIG. 1, the liquid crystal display 100 utilizes a control circuit with the predetermined color sequence to turn on a red LED, a green LED, a blue LED, and a white LED corresponding to each pixel in turn to form a predetermined color corresponding to each pixel.

However, the white LED corresponding to the pixel may be too hot or have power attenuation after the white LED corresponding to the pixel is used for a period of time, so that white balance of the liquid crystal display 100 may be shifted. In addition, different types of white LEDs also have different default white balance values. Therefore, a user may notice shifted white light of the liquid crystal display 100 (such as the white light shifted to red light) when the user observes the liquid crystal display 100.

### SUMMARY OF THE INVENTION

An embodiment provides a display capable of calibrating white balance. The display includes a display panel, a backlight module, and a timing controller, where the display panel is used for displaying image data according to red light, green light, blue light, and/or white light provided by the backlight module according to the image data, and the backlight module is installed below the display panel. The display panel includes a plurality of pixels. The backlight module includes a plurality of red light emitting diodes (LEDs), a plurality of green LEDs, a plurality of blue LEDs, and a plurality of white LEDs for providing the red light, green light, blue light, and white light to the display panel, where each pixel of the plurality of pixels corresponds to a red LED, a green LED, a blue LED, and a white LED. The timing controller includes a sensing controller and a color sequential display driver controller. The sensing controller stores a lookup table. The sensing controller includes a sequential sensing unit and an LED control unit. The sequential sensing unit is used for receiving luminances of red light, green light, blue light, and white light corresponding to the pixel detected by the backlight module, and a temperature of the backlight module when the backlight module provides red light, green light, blue light, and white light to the display panel according to the image data. The LED control unit is used for controlling the backlight module to adjust the luminances of the red light, green light, blue light, and/or white light corresponding to the pixel, and adjusting the temperature of the backlight module when the backlight module provides the red light, green light, blue light, and white light to the display panel according to the image data according to the lookup table, the luminances of the red light, green light, blue light, and white light corresponding to the pixel, and the temperature. The color sequential display driver controller is used for generating a synchronous signal according to the image data, where an interval between each two consecutive synchronous signals corresponds to a predetermined color sequence of the red light, green light, blue light, and white light provided to the display panel by the backlight module according to the image data.

Another embodiment provides a white balance calibration method. The method includes providing red light, green light, blue light, and white light to a display panel according to image data; detecting a temperature of a backlight module when the backlight module provides the red light, green light, blue light, and white light to the display panel according to the image data; generating a calibration signal according to a difference when the difference between the temperature and a standard temperature stored in a lookup table corresponding to the backlight module is greater than a predetermined value; adjusting driving currents flowing through a plurality of red LEDs, a plurality of green LEDs, a plurality of blue LEDs and/or a plurality of white LEDs comprised by the backlight module according to the calibration signal and the lookup table.

Another embodiment provides a white balance calibration method. The method includes providing red light, green light, blue light, and white light to a display panel according to first image data; detecting a first temperature of a backlight module when the backlight module provides the red light, green light, blue light, and white light to the display panel according to the first image data; detecting whether at least one luminance of red light, green light, and blue light corresponding to each pixel is lower than maximum luminances of a red LED, a green LED, and a blue LED corresponding to the pixel when a first difference between the first temperature and a standard temperature stored in a lookup table corresponding to the backlight module is lower than a predetermined value; performing a first corresponding operation according to a first determination result.

Another embodiment provides a white balance calibration method. The method includes providing red light, green light, blue light, and white light to a display panel according to first image data; detecting a first temperature of a backlight module when the backlight module provides the red light, green light, blue light, and white light to the display panel according to the first image data; detecting whether luminance of white light corresponding to each pixel is lower than maximum luminance of a white LED corresponding to the pixel when the difference between the first temperature and a standard temperature stored in a lookup table corresponding to the backlight module is greater than a predetermined value; controlling the backlight module to turn on a red LED, a green LED, and a blue LED corresponding to the pixel during turning-on of white light corresponding to the pixel if the luminance of the white light corresponding to the pixel is lower than the maximum luminance of the white LED corresponding to the pixel.

The present invention provides a display capable of calibrating white balance and method thereof. The display and the method thereof first utilize a thermal sensor of a backlight module to detect a temperature of the backlight module when the backlight module provides red light, green light, blue light, and white light to a display panel, and utilize an LED control unit of a timing controller to control a backlight module driving unit of the backlight module to calibrate color shift of the backlight module according to the temperature of the backlight module. After calibrating the color shift of the backlight module, the LED control unit can control the backlight module driving unit of the backlight module to turn on a red LED, a green LED, and a blue LED corresponding to a pixel simultaneously or in turn during turning-on of white light corresponding to the pixel between two consecutive synchronous signals for calibrating the white light corresponding to the pixel. Thus, the present invention can reduce power consumption of a white LED of the backlight module corresponding to the pixel, increase life of the white LED of the backlight module corresponding to the pixel, and be applied to different types of white LEDs.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a liquid crystal display with a predetermined color sequence utilizing a red LED, a green LED, a blue LED, and a white LED corresponding to each pixel to form a predetermined color according to the prior art.

FIG. 2 is a diagram illustrating a display capable of calibrating white balance according to an embodiment.

FIG. 3A and FIG. 3B are diagrams illustrating the LED control unit controlling the backlight module driving unit of the backlight module to turn on the red LED, the green LED, and the blue LED corresponding to the pixel during turning-on of the white light corresponding to the pixel when the luminance of the white light corresponding to the pixel is lower than the maximum luminance of the white LED corresponding to the pixel.

FIG. 4A and FIG. 4B are flowcharts illustrating a white balance calibration method according to another embodiment.

FIG. 5 is a flowchart illustrating a white balance calibration method according to another embodiment.

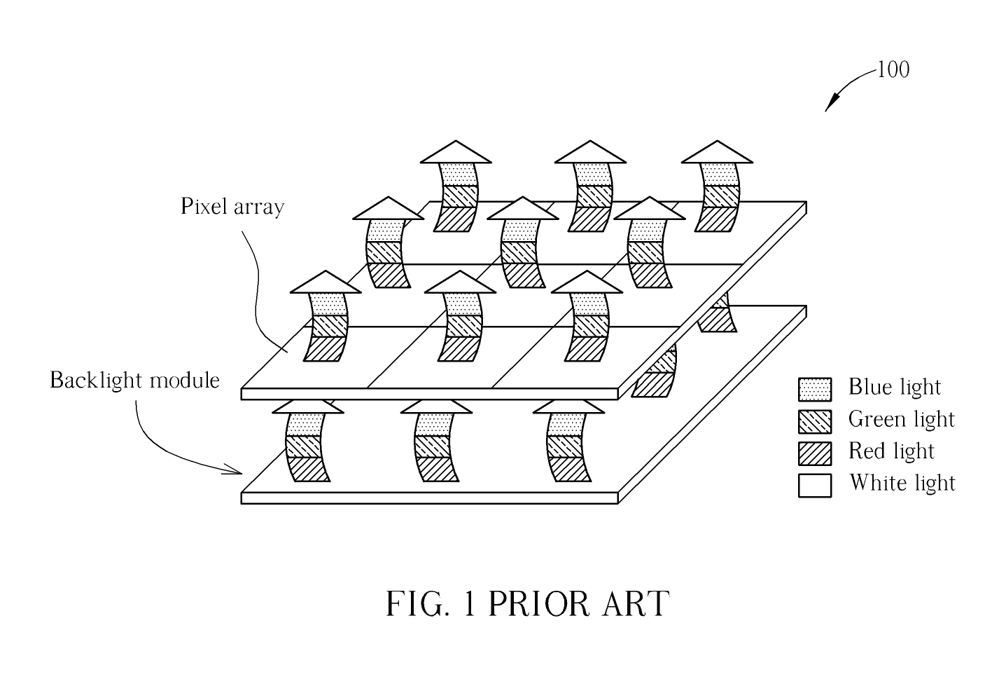

### DETAILED DESCRIPTION

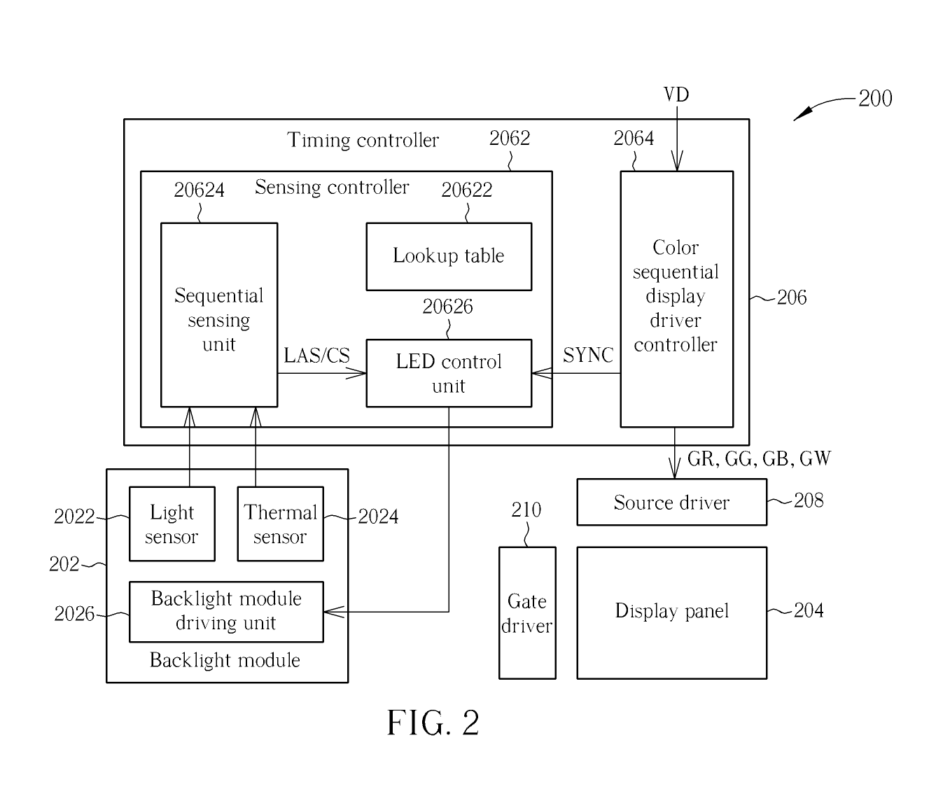

Please refer to FIG. 2. FIG. 2 is a diagram illustrating a display 200 capable of calibrating white balance according to an embodiment. The display 200 includes a backlight module 202, a display panel 204, a timing controller 206, a source driver 208, and a gate driver 210. The backlight module 202 includes a plurality of red light emitting diodes (LEDs), a plurality of green LEDs, a plurality of blue LEDs, and a plurality of white LEDs for providing red light, green light, blue light, and white light for the display panel 204. The display panel 204 includes a plurality of pixels, where each pixel of the plurality of pixels corresponds to a red LED, a green LED, a blue LED, and a white LED. In addition, the display panel 204 is used for displaying image data VD according to the red light, green light, blue light, and/or white light provide by the backlight module 202, and the backlight module 202 is installed below the display panel 204. The timing controller 206 includes a sensing controller 2062 and a color sequential display driver controller 2064. The sensing controller 2062 stores a lookup table 20622, where the sensing controller 2062 includes a sequential sensing unit 20624 and an LED control unit 20626. The sequential sensing unit 20624 is used for receiving luminances of red light, green light, blue light, and white light corresponding to the pixel detected by the backlight module 202, and a temperature of the backlight module 202 when the backlight module 202 provides red light, green light, blue light, and white light according to the image data VD. The LED control unit 20626 is used for controlling the backlight module 202 to adjust the luminances of the red light, green light, blue light, and/or white light corresponding to the pixel, and adjusting the temperature of the backlight module when the backlight module 202 provides the red light, green light, blue light, and white light according to the image data VD according to the lookup table 20622, the luminances of the red light, green light, blue light, and white light corresponding to the pixel, and the temperature of the backlight module 202. The color sequential display driver controller 2064 is used for generating a synchronous signal SYNC to the LED control unit 20626 according to the image data VD, and generating gray levels GR, GG, GB, and GW corresponding to red light, green light, blue light, and white light of the image data VD, where an interval between each two consecutive synchronous signals corresponds to a predetermined color sequence of the red light, green light, blue light, and white light provided by the backlight module 202. The source driver 208 is used for driving the display panel 204 to display the image data VD according to the gray levels GR, GG, GB, and GW corresponding to the red light, green light, blue light, and white light of the image data VD provided by the color sequential display driver controller 2064, and the predetermined color sequence. The gate driver 210 is used for controlling gate lines of the display panel 204 to operate the display panel 204 according to a timing corresponding to the image data VD.

As shown in FIG. 2, the backlight module 202 further includes a light sensor 2022, a thermal sensor 2024, and a backlight module driving unit 2026. The light sensor 2022 is used for detecting luminances of red light, green light, blue light, and white light corresponding to each pixel, and outputting the luminances of the red light, green light, blue light, and white light corresponding to the pixel to the sequential sensing unit 20624. The thermal sensor 2024 is used for detecting the temperature of the backlight module 202 when the backlight module 202 provides the red light, green light, blue light, and white light to the display panel 204 according to the image data VD, and outputting the temperature of the backlight module 202 to the sequential sensing unit 20624. The backlight module driving unit 2026 is used for adjusting driving currents flowing through a red LED, a green LED, a blue LED, and a white LED corresponding to each pixel. In addition, the LED control unit 20626 controls the backlight module driving unit 2026 to drive the plurality of red LEDs, the plurality of green LEDs, the plurality of blue LEDs, and the plurality of white LEDs included by the backlight module 202 according to the synchronous signal SYNC and the predetermined color sequence. Further, the lookup table 20622 further includes relationships between temperatures, luminance, and driving currents of the plurality of red LEDs, relationships between temperatures, luminance, and driving currents of the plurality of green LEDs, relationships between temperatures, luminance, and driving currents of the plurality of blue LEDs, and relationships between temperatures, luminance, and driving currents of the plurality of white LEDs.

When the display 200 is powered on, the display 200 is set to enter a white balance calibration mode. That is to say, the display 200 continues to perform white balance calibration before the display 200 is powered off. But, the present invention is not limited to the display 200 being set to enter the white balance calibration mode. That is to say, a user can also determine whether the display 200 enters the white balance calibration mode. After the display 200 is powered on, the backlight module 202 provides the red light, green light, blue light, and white light for the display panel 204 according to the image data VD, and the thermal sensor 2024 detects the temperature of the backlight module 202 when the backlight module 202 provides the red light, green light, blue light, and white light to the display panel 204 according to the image data VD. When a difference between the temperature of the backlight module 202 and a standard temperature stored in the lookup table 20622 corresponding to the backlight module 202 is greater than a predetermined value ΔT, the sequential sensing unit 20624 of the sensing controller 2062 generates a calibration signal CS according to the difference. The LED control unit 20626 can control the backlight module driving unit 2026 of the backlight module 202 to adjust driving currents flowing through the plurality of red LEDs, the plurality of green LEDs, the plurality of blue LEDs, and/or the plurality of white LEDs included by the backlight module 202 for adjusting the temperature of the backlight module 202 according to the calibration signal CS and the lookup table 20622. That is to say, the LED control unit 20626 can control the backlight module driving unit 2026 of the backlight module 202 to calibrate color shift of the backlight module 202 according to the calibration signal CS and the lookup table 20622. Then, the thermal sensor 2024 continues detecting the temperature of the backlight module 202 until the difference between the temperature of the backlight module 202 and the standard temperature stored in the lookup table 20622 corresponding to the backlight module 202 is less than the predetermined value ΔT.

When the difference between the temperature of the backlight module 202 and the standard temperature stored in the lookup table 20622 corresponding to the backlight module 202 is less than the predetermined value ΔT, the light sensor 2022 detects whether at least one luminance of red light, green light, and blue light corresponding to each pixel is lower than maximum luminance of red LED, green LED, and blue LED corresponding to the pixel. When the light sensor 2022 detects the at least one luminance of the red light, green light, and blue light corresponding to the pixel is lower than the maximum luminance of the red LED, green LED, and blue LED corresponding to the pixel, the backlight module 202 reduces driving currents of LEDs not corresponding to minimum luminance of the luminances of the red light, green light, and blue light corresponding to the pixel according to the minimum luminance of the luminances of the red light, green light, and blue light corresponding to the pixel. That is to say, the sequential sensing unit 20624 generates a luminance adjustment signal LAS to the LED control unit 20626 when the light sensor 2022 detects the at least one luminance of the red light, green light, blue light, and white light corresponding to the pixel is lower than the maximum luminance of the red LED, green LED, and blue LED corresponding to the pixel. Then, the LED control unit 20626 can control the backlight module driving unit 2026 of the backlight module 202 to reduce the driving currents of the LEDs not corresponding to the minimum luminance of the luminances of the red light, green light, and blue light corresponding to the pixel according to the luminance adjustment signal LAS. For example, the backlight module driving unit 2026 of the backlight module 202 reduces driving currents of a green LED and a blue LED corresponding to a pixel to decrease green light of the pixel to 80% of maximum luminance of the green LED and blue light of the pixel to 80% of maximum luminance of the blue LED when luminance of red light of the pixel is only 80% of maximum luminance of a red LED corresponding to the pixel because the red Led has aged. Meanwhile, the sequential sensing unit 20624 of the sensing controller 2062 compares the temperature of the backlight module 202 with the standard temperature stored in the lookup table 20622 corresponding to the backlight module 202 again to determine whether calibration signal CS is generated.

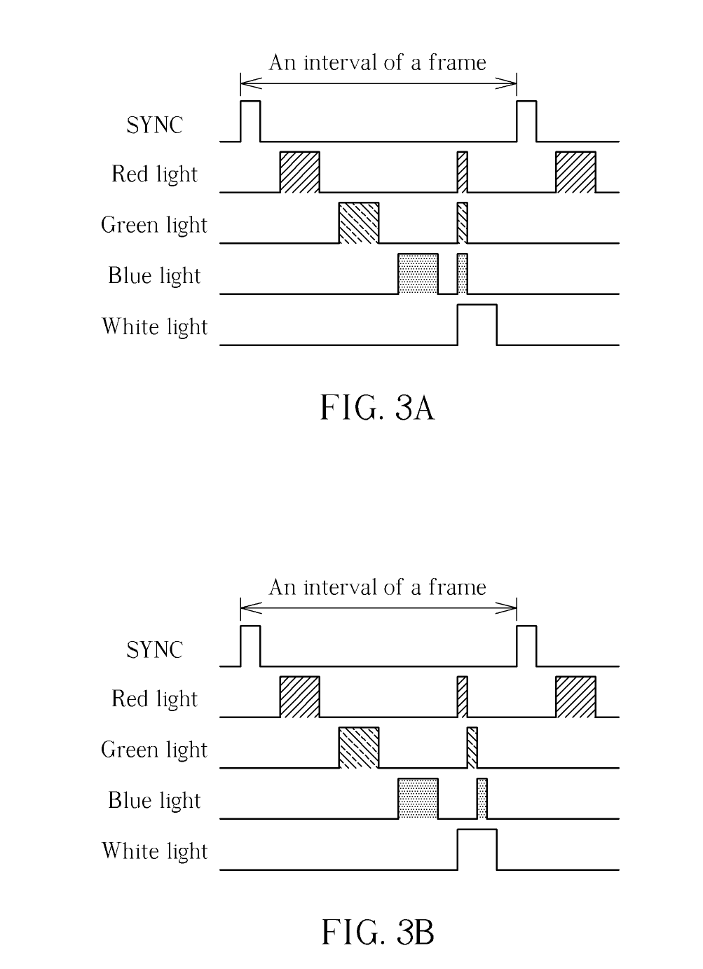

In addition, the light sensor 2022 detects whether the luminance of the white light corresponding to the pixel is lower than maximum luminance of the white LED corresponding to the pixel when the difference between the temperature of the backlight module 202 and a standard temperature stored in the lookup table 20622 corresponding to the backlight module 202 is less than the predetermined value ΔT, and the luminances of the red light, green light, and blue light corresponding to the pixel detected by the light sensor 2022 are equal to the maximum luminances of the red LED, the green LED, and the blue LED corresponding to the pixel, respectively. Please refer to FIG. 3A and FIG. 3B. FIG. 3A and FIG. 3B are diagrams illustrating the LED control unit 20626 controlling the backlight module driving unit 2026 of the backlight module 202 to turn on the red LED, the green LED, and the blue LED corresponding to the pixel during turning-on of the white light corresponding to the pixel when the luminance of the white light corresponding to the pixel is lower than the maximum luminance of the white LED corresponding to the pixel.

As shown in FIG. 3A, the LED control unit 20626 controls the backlight module driving unit 2026 of the backlight module 202 to turn on the red LED, the green LED, and the blue LED corresponding to the pixel simultaneously during turning-on of the white light corresponding to the pixel between two consecutive synchronous signals when the luminance of the white light corresponding to the pixel detected by the light sensor 2022 is lower than the maximum luminance of the white LED corresponding to the pixel (because the white LED corresponding to the pixel has aged).

As shown in FIG. 3B, the LED control unit 20626 controls the backlight module driving unit 2026 of the backlight module 202 to turn on the red LED, the green LED, and the blue LED corresponding to the pixel in turn during turning-on of the white light corresponding to the pixel between two consecutive synchronous signals when the luminance of the white light corresponding to the pixel detected by the light sensor 2022 is lower than the maximum luminance of the white LED corresponding to the pixel (because the white LED corresponding to the pixel has aged). Thus, the display 200 can prevent instantaneous power consumption of the backlight module 202 from being sharply increased, and reduce the instantaneous power consumption of the backlight module 202. In addition, in FIG. 3A and FIG. 3B, an interval of turning-on the red LED, an interval of turning-on the green LED, and an interval of turning-on the blue LED during turning-on of the white light between the two consecutive synchronous signals vary with the white light of the pixel. That is to say, the interval of turning-on the red LED, the interval of turning-on the green LED, and the interval of turning-on the blue LED during turning-on of the white light between the two consecutive synchronous signals can be the same or different. In addition, the methods in FIG. 3A and FIG. 3B are not limited to being applied to the aged white LED of the pixel. That is to say, the methods in FIG. 3A and FIG. 3B can also be applied to calibrate different types of white LEDs.

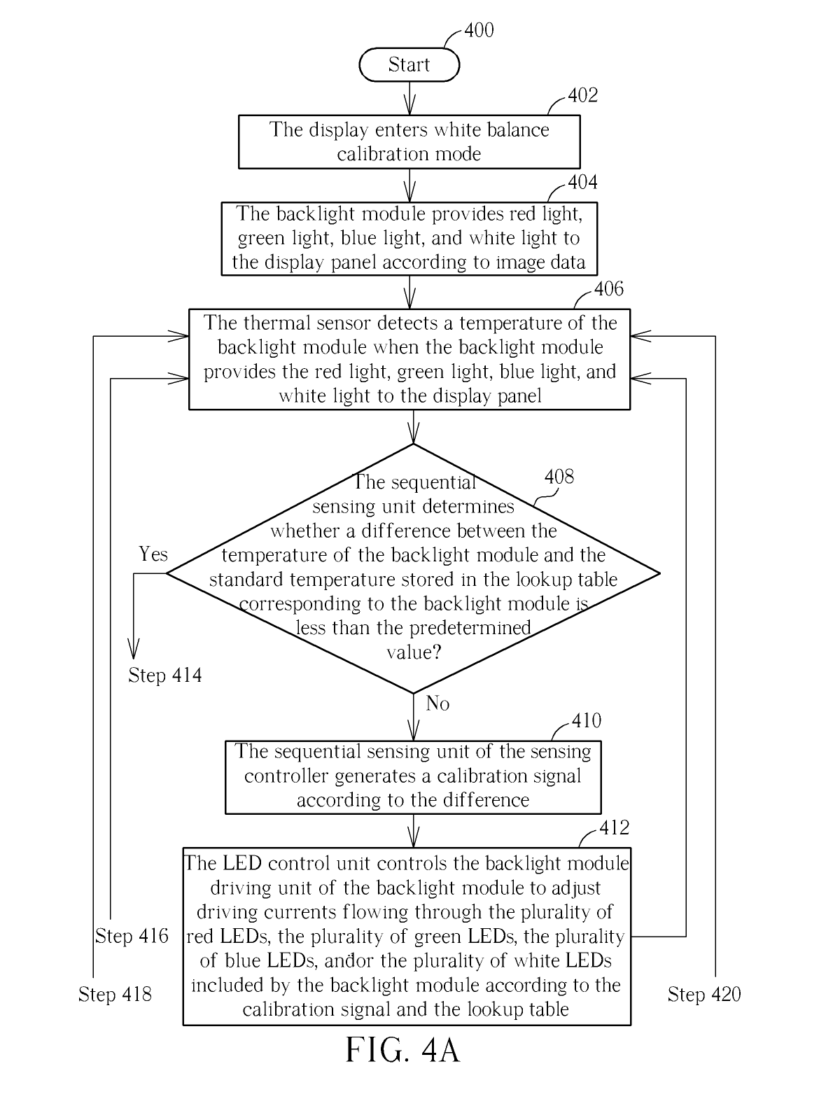

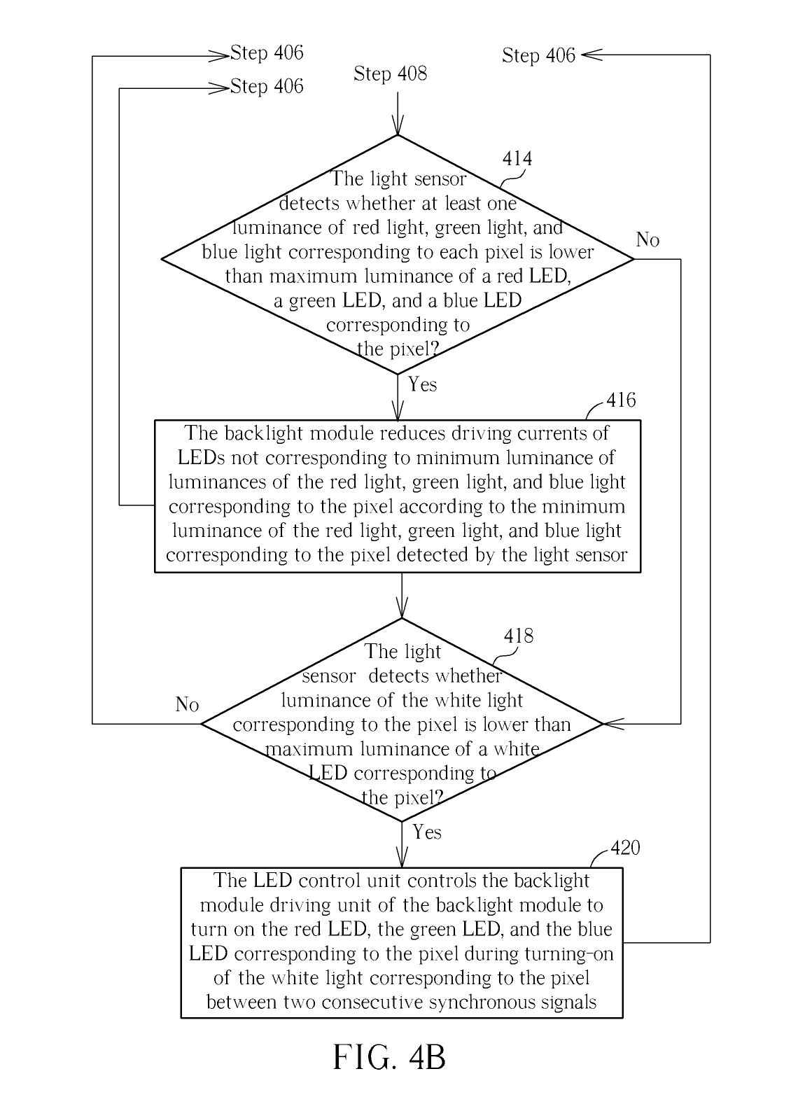

Please refer to FIG. 4A and FIG. 4B. FIG. 4A and FIG. 4B are flowcharts illustrating a white balance calibration method according to another embodiment. The methods in FIG. 4A and FIG. 4B are illustrated using the display 200 in FIG. 2. Detailed steps are as follows:

Step 400: Start.

Step 402: The display 200 enters white balance calibration mode.

Step 404: The backlight module 202 provides red light, green light, blue light, and white light to the display panel 204 according to image data VD.

Step 406: The thermal sensor 2024 detects a temperature of the backlight module 202 when the backlight module 202 provides the red light, green light, blue light, and white light to the display panel 204.

Step 408: The sequential sensing unit 20624 determines whether a difference between the temperature of the backlight module 202 and the standard temperature stored in the lookup table 20622 corresponding to the backlight module 202 is less than the predetermined value ΔT. If yes, go to Step 414; if no, go to Step 410.

Step 410: The sequential sensing unit 20624 of the sensing controller 2062 generates a calibration signal CS according to the difference.

Step 412: The LED control unit 20626 controls the backlight module driving unit 2026 of the backlight module 202 to adjust driving currents flowing through the plurality of red LEDs, the plurality of green LEDs, the plurality of blue LEDs, and/or the plurality of white LEDs included by the backlight module 202 according to the calibration signal CS and the lookup table 20622; go to Step 406.

Step 414: The light sensor 2022 detects whether at least one luminance of red light, green light, and blue light corresponding to each pixel is lower than maximum luminance of a red LED, a green LED, and a blue LED corresponding to the pixel. If yes, go to Step 416; if no, go to Step 418.

Step 416: The backlight module 202 reduces driving currents of LEDs not corresponding to minimum luminance of luminances of the red light, green light, and blue light corresponding to the pixel according to the minimum luminance of the red light, green light, and blue light corresponding to the pixel detected by the light sensor 2022; go to Step 406.

Step 418: The light sensor 2022 detects whether luminance of the white light corresponding to the pixel is lower than maximum luminance of a white LED corresponding to the pixel. If yes, go to Step 420; if no, go to Step 406.

Step 420: The LED control unit 20626 controls the backlight module driving unit 2026 of the backlight module 202 to turn on the red LED, the green LED, and the blue LED corresponding to the pixel during turning-on of the white light corresponding to the pixel between two consecutive synchronous signals; go to Step 406.

In Step 412, because the lookup table 20622 includes the relationships between the temperatures, the luminance, and the driving currents of the plurality of red LEDs, the relationships between the temperatures, the luminance, and the driving currents of the plurality of green LEDs, the relationships between the temperatures, the luminance, and the driving currents of the plurality of blue LEDs, and the relationships between the temperatures, the luminance, and the driving currents of the plurality of white LEDs, the LED control unit 20626 can control the backlight module driving unit 2026 of the backlight module 202 to adjust the driving currents flowing through the plurality of red LEDs, the plurality of green LEDs, the plurality of blue LEDs, and/or the plurality of white LEDs included by the backlight module 202 for adjusting the temperature of the backlight module 202 according to the calibration signal CS and the lookup table 20622. That is to say, the LED control unit 20626 can control the backlight module driving unit 2026 of the backlight module 202 to calibrate color shift of the backlight module 202 according to the calibration signal CS and the lookup table 20622. In Step 416, when the light sensor 2022 detects the at least one luminance of the red light, green light, and blue light corresponding to the pixel is lower than the maximum luminance of the red LED, green LED, and blue LED corresponding to the pixel, the sequential sensing unit 20624 generates the luminance adjustment signal LAS to the LED control unit 20626. Then, the LED control unit 20626 can control the backlight module driving unit 2026 of the backlight module 202 to reduce the driving currents of LEDs not corresponding to the minimum luminance of the luminances of the red light, green light, and blue light corresponding to the pixel according to the minimum luminance of the luminances of the red light, green light, and blue light corresponding to the pixel according to the luminance adjustment signal LAS and the lookup table 20622. In Step 420, as shown in FIG. 3A and FIG. 3B, the LED control unit 20626 controls the backlight module driving unit 2026 of the backlight module 202 to turn on the red LED, the green LED, and the blue LED corresponding to the pixel simultaneously during turning-on of the white light corresponding to the pixel between the two consecutive synchronous signals (as shown in FIG. 3A), or to turn on the red LED, the green LED, and the blue LED corresponding to the pixel in turn during turning-on of the white light corresponding to the pixel between the two consecutive synchronous signals (as shown in FIG. 3B). In addition, the interval of turning on the red LED, the interval of turning on the green LED, and the interval of turning on the blue LED during turning-on of the white light between the two consecutive synchronous signals vary with the white light of the pixel.

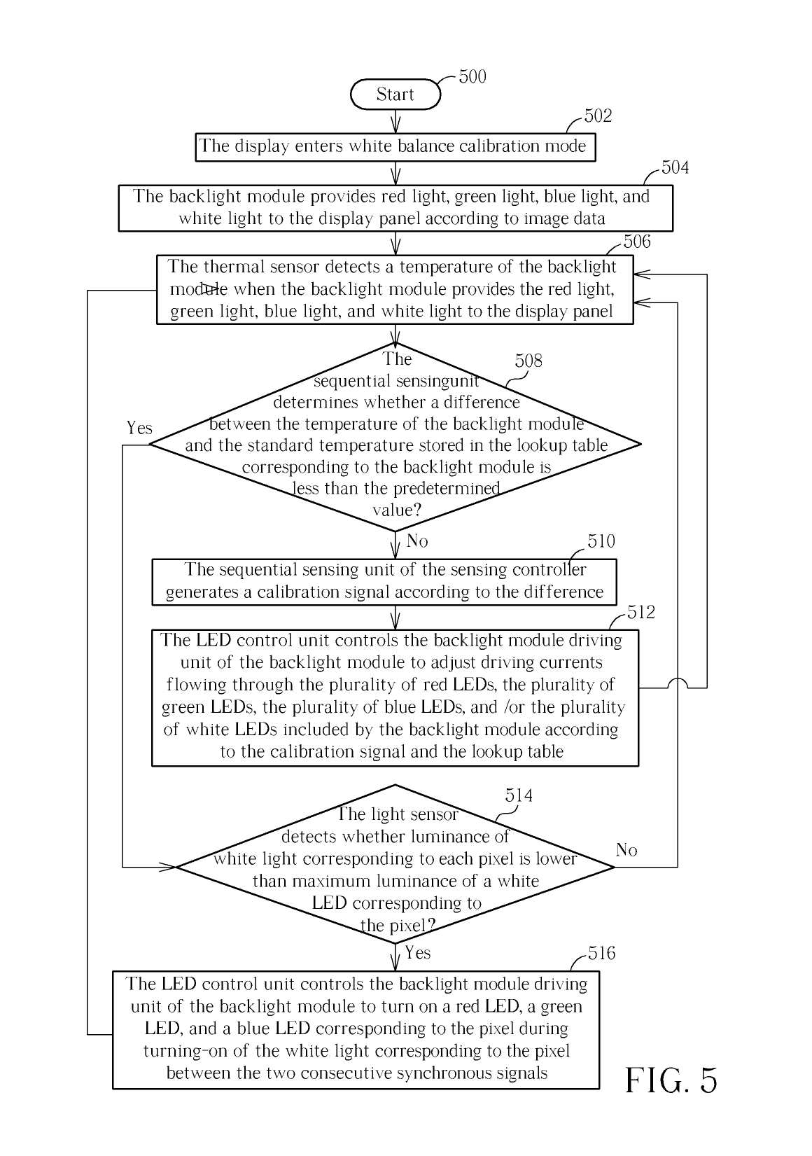

Please refer to FIG. 5. FIG. 5 is a flowchart illustrating a white balance calibration method according to another embodiment. The method in FIG. 5 is illustrated using the display 200 in FIG. 2. Detailed steps are as follows:

Step 500: Start.

Step 502: The display 200 enters white balance calibration mode.

Step 504: The backlight module 202 provides red light, green light, blue light, and white light to the display panel 204 according to image data VD.

Step 506: The thermal sensor 2024 detects a temperature of the backlight module 202 when the backlight module 202 provides the red light, green light, blue light, and white light to the display panel 204.

Step 508: The sequential sensing unit 20624 determines whether a difference between the temperature of the backlight module 202 and the standard temperature stored in the lookup table 20622 corresponding to the backlight module 202 is less than the predetermined value ΔT. If yes, go to Step 514; if no, go to Step 510.

Step 510: The sequential sensing unit 20624 of the sensing controller 2062 generates a calibration signal CS according to the difference.

Step 512: The LED control unit 20626 controls the backlight module driving unit 2026 of the backlight module 202 to adjust driving currents flowing through the plurality of red LEDs, the plurality of green LEDs, the plurality of blue LEDs, and/or the plurality of white LEDs included by the backlight module 202 according to the calibration signal CS and the lookup table 20622; go to Step 506.

Step 514: The light sensor 2022 detects whether luminance of white light corresponding to each pixel is lower than maximum luminance of a white LED corresponding to the pixel. If yes, go to Step 516; if no, go to Step 506.

Step 516: The LED control unit 20626 controls the backlight module driving unit 2026 of the backlight module 202 to turn on a red LED, a green LED, and a blue LED corresponding to the pixel during turning-on of the white light corresponding to the pixel between the two consecutive synchronous signals; go to Step 506.

A difference between the embodiment in FIG. 5 and the embodiment in FIG. 4A and FIG. 4B is that the light sensor 2022 only detects whether the luminance of the white light corresponding to the pixel is lower than the maximum luminance of the white LED corresponding to the pixel, and does not detect whether at least one luminance of red light, green light, and blue light corresponding to the pixel is lower than maximum luminance of a red LED, a green LED, and a blue LED corresponding to the pixel. That is to say, the embodiment in FIG. 5 only utilizes the red LED, green LED, and blue LED corresponding to the pixel to calibrate the white light corresponding to the pixel. Further, subsequent operational principles of the embodiment in FIG. 5 are the same as those of the embodiment in FIG. 4A and FIG. 4B, so further description thereof is omitted for simplicity.

To sum up, the display capable of calibrating the white balance and the method thereof first utilize the thermal sensor of the backlight module to detect the temperature of the backlight module when the backlight module provides the red light, green light, blue light, and white light to the display panel, and utilize the LED control unit of the timing controller to control the backlight module driving unit of the backlight module to calibrate the color shift of the backlight module according to the temperature of the backlight module. After calibrating the color shift of the backlight module, the LED control unit can control the backlight module driving unit of the backlight module to turn on the red LED, the green LED, and the blue LED corresponding to the pixel simultaneously or in turn during turning-on of the white light corresponding to the pixel between the two consecutive synchronous signals for calibrating the white light corresponding to the pixel. Thus, the present invention can reduce power consumption of the white LED of the backlight module corresponding to the pixel, increase life of the white LED of the backlight module corresponding to the pixel, and be applied to different types of white LEDs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display capable of calibrating white balance, the display comprising:
a display panel comprising a plurality of pixels;
a backlight module comprising a plurality of red light emitting diodes (LEDs), a plurality of green LEDs, a plurality of blue LEDs, and a plurality of white LEDs for providing red light, green light, blue light, and white light to the display panel, wherein each pixel of the plurality of pixels corresponds to a red LED, a green LED, a blue LED, and a white LED; and
a timing controller comprising:
a sensing controller storing a lookup table, the sensing controller comprising:
a sequential sensing unit for receiving luminances of red light, green light, blue light, and white light corresponding to the pixel detected by the backlight module, and a temperature of the backlight module when the backlight module provides red light, green light, blue light, and white light to the display panel according to image data; and
an LED control unit for controlling the backlight module to adjust the luminances of the red light, green light, blue light, and/or white light corresponding to the pixel, and adjusting the temperature of the backlight module when the backlight module provides the red light, green light, blue light, and white light to the display panel according to the image data according to the lookup table, the luminances of the red light, green light, blue light, and white light corresponding to the pixel, and the temperature; and
a color sequential display driver controller for generating a synchronous signal according to the image data, wherein an interval between each two consecutive synchronous signals corresponds to a predetermined color sequence of the red light, green light, blue light, and white light provided to the display panel by the backlight module according to the image data;
wherein the display panel displays the image data according to the red light, green light, blue light, and/or white light provided to the display panel by the backlight module according to the image data, and the backlight module is installed below the display panel.

2. The display of claim 1, wherein the LED control unit controls the backlight module to adjust driving currents flowing through the plurality of red LEDs, the plurality of green LEDs, the plurality of blue LEDs, and/or the plurality of white LEDs for adjusting the temperature according to the temperature and a standard temperature stored in the lookup table corresponding to the backlight module.

3. The display of claim 1, wherein the LED control unit controls the backlight module to reduce driving currents of LEDs not corresponding to minimum luminance of at least one luminance of the red light, green light, and blue light corresponding to the pixel according to the minimum luminance of the at least one luminance when the LED control unit determines the at least one luminance of the red light, green light, and blue light corresponding to the pixel is lower than maximum luminance of the red LED, the green LED, and the blue LED corresponding to the pixel.

4. The display of claim 1, wherein the LED control unit controls the backlight module to turn on the red LED, the green LED, and the blue LED corresponding to the pixel during turning-on of the white light corresponding to the pixel between the two consecutive synchronous signals when the LED control unit determines the luminance of the white light corresponding to the pixel is lower than maximum luminance of the white LED corresponding to the pixel.

5. The display of claim 1, wherein the backlight module further comprises:
a light sensor for detecting and outputting the luminances of the red light, green light, blue light, and white light corresponding to the pixel;
a thermal sensor for detecting and outputting the temperature of the backlight module when the backlight module provides the red light, green light, blue light, and white light to the display panel; and
a backlight module driving unit for adjusting driving currents flowing through the red LED, the green LED, the blue LED, and the white LED corresponding to the pixel.

6. The display of claim 1, further comprising:
a source driver for driving the display panel to display the image data according to gray levels provided by the color sequential display driver controller, wherein the gray levels correspond to red light, green light, blue light, and white light of the image data; and
a gate driver for controlling gate lines of the display panel to operate the display panel.

7. The display of claim 1, wherein the lookup table further comprises relationships between temperatures, luminance, and driving currents of the plurality of red LEDs, relationships between temperatures, luminance, and driving currents of the plurality of green LEDs, relationships between temperatures, luminance, and driving currents of the plurality of blue LEDs, and relationships between temperatures, luminance, and driving currents of the plurality of white LEDs.

8. A white balance calibration method, comprising:
providing red light, green light, blue light, and white light to a display panel according to image data;
detecting a temperature of a backlight module when the backlight module provides the red light, green light, blue light, and white light to the display panel according to the image data;
generating a calibration signal according to a difference when the difference between the temperature and a standard temperature stored in a lookup table corresponding to the backlight module is greater than a predetermined value; and
adjusting driving currents flowing through a plurality of red LEDs, a plurality of green LEDs, a plurality of blue LEDs and/or a plurality of white LEDs comprised by the backlight module according to the calibration signal and the lookup table.

9. The method of claim 8, further comprising:
entering a white balance calibration mode.

10. A white balance calibration method, comprising:
providing red light, green light, blue light, and white light to a display panel according to first image data;
detecting a first temperature of a backlight module when the backlight module provides the red light, green light, blue light, and white light to the display panel according to the first image data;
detecting whether at least one luminance of red light, green light, and blue light corresponding to each pixel is lower than maximum luminances of a red LED, a green LED, and a blue LED corresponding to the pixel when a first difference between the first temperature and a standard temperature stored in a lookup table corresponding to the backlight module is lower than a predetermined value; and
performing a first corresponding operation according to a first determination result.

11. The method of claim 10, wherein a backlight module driving unit reduces driving currents of LEDs not corresponding to minimum luminance of at least one luminance of the red light, green light, and blue light corresponding to the pixel according to the minimum luminance of the at least one luminance when the first determination result is that the at least one luminance of the red light, green light, and blue light corresponding to the pixel is lower than the maximum luminance of the red LED, the green LED, and the blue LED corresponding to the pixel.

12. The method of claim 10, wherein performing the first corresponding operation according to the first determination result is detecting whether luminance of white light corresponding to the pixel is lower than maximum luminance of a white LED corresponding to the pixel, and performing a second corresponding operation according to a second determination result when the first determination result is that the luminances of the red light, green light, and blue light corresponding to the pixel are equal to the maximum luminances of the red LED, the green LED, and the blue LED corresponding to the pixel, respectively.

13. The method of claim 12, wherein performing the second corresponding operation according to the second determination result is controlling the backlight module to turn on the red LED, the green LED, and the blue LED corresponding to the pixel during turning-on of the white light corresponding to the pixel between the two consecutive synchronous signals according to the second determination result when the second determination result is that the luminance of the white light corresponding to the pixel is lower than the maximum luminance of the white LED corresponding to the pixel.

14. The method of claim 13, wherein controlling the backlight module to turn on the red LED, the green LED, and the blue LED corresponding to the pixel during turning-on of the white light corresponding to the pixel between the two consecutive synchronous signals is controlling the backlight module to turn on the red LED, the green LED, and the blue LED corresponding to the pixel simultaneously during turning-on of the white light corresponding to the pixel between the two consecutive synchronous signals.

15. The method of claim 13, wherein controlling the backlight module to turn on the red LED, the green LED, and the blue LED corresponding to the pixel during turning-on of the white light corresponding to the pixel between the two consecutive synchronous signals is controlling the backlight module to turn on the red LED, the green LED, and the blue LED corresponding to the pixel in turn during turning-on of the white light corresponding to the pixel between the two consecutive synchronous signals.

16. The method of claim 10, further comprising:
entering a white balance calibration mode.

17. The method of claim 10, further comprising:
the backlight module providing red light, green light, blue light, and white light to the display panel according to second image data;
detecting a second temperature of the backlight module when the backlight module provides the red light, green light, blue light, and white light to the display panel according to the second image data;
generating a calibration signal according to a second difference when the second difference between the second temperature and the standard temperature stored in the lookup table corresponding to the backlight module is greater than the predetermined value; and
adjusting driving currents flowing through a plurality of red LEDs, a plurality of green LEDs, a plurality of blue LEDs and/or a plurality of white LEDs comprised by the backlight module according to the calibration signal.

18. A white balance calibration method, comprising:
providing red light, green light, blue light, and white light to a display panel according to first image data;
detecting a first temperature of a backlight module when the backlight module provides the red light, green light, blue light, and white light to the display panel according to the first image data;
detecting whether luminance of white light corresponding to each pixel is lower than maximum luminance of a white LED corresponding to the pixel when the difference between the first temperature and a standard temperature stored in a lookup table corresponding to the backlight module is greater than a predetermined value; and
controlling the backlight module to turn on a red LED, a green LED, and a blue LED corresponding to the pixel during turning-on of white light corresponding to the pixel if the luminance of the white light corresponding to the pixel is lower than the maximum luminance of the white LED corresponding to the pixel.

19. The method of claim 18, wherein controlling the backlight module to turn on the red LED, the green LED, and the blue LED corresponding to the pixel during turning-on of the white light corresponding to the pixel is controlling the backlight module to turn on the red LED, the green LED, and the blue LED corresponding to the pixel simultaneously during turning-on of the white light corresponding to the pixel between two consecutive synchronous signals.

20. The method of claim 18, wherein controlling the backlight module to turn on the red LED, the green LED, and the blue LED corresponding to the pixel during turning-on of the white light corresponding to the pixel is controlling the backlight module to turn on the red LED, the green LED, and the blue LED corresponding to the pixel in turn during turning-on of the white light corresponding to the pixel between two consecutive synchronous signals.

21. The method of claim 18, further comprising:
the backlight module providing red light, green light, blue light, and white light to the display panel according to second image data;
detecting a second temperature of the backlight module when the backlight module provides the red light, green light, blue light, and white light to the display panel according to the second image data;
generating a calibration signal according to a second difference when the second difference between the second temperature and the standard temperature stored in the lookup table corresponding to the backlight module is greater than the predetermined value; and
adjusting driving currents flowing through a plurality of red LEDs, a plurality of green LEDs, a plurality of blue LEDs and/or a plurality of white LEDs comprised by the backlight module according to the calibration signal.

22. The method of claim 18, further comprising:
entering a white balance calibration mode.
